(19) United States
(12) Patent Application Publication
(10) Pub. No.: US 2018/0075463 A1
(43) Pub. Date: Mar. 15, 2018

(54) ENTITY STATE DATA DETECTION UNIT

(71) Applicant: Hokisym, New York, NY (US)

(72) Inventor: Merav Ozair, New York, NY (US)

(21) Appl. No.: 15/555,192

(22) PCT Filed: Mar. 2, 2016
(86) PCT No.: PCT/US16/20508

§ 371 Date: Sep. 1, 2017

Related U.S. Application Data
(60) Provisional application No. 62/126,721, filed on Mar. 2, 2015.

(51) Int. Cl. G06Q 30/02; G06F 17/30; G06Q 10/06

(52) U.S. Cl. CPC G06Q 30/0202; G06F 17/30528; G06Q 10/067; G06Q 30/0201; G06Q 10/0635; G06F 17/30554

(57) ABSTRACT

Technologies are described for methods and systems effective to output state data related to an entity. A processor may fetch source data from data sources to produce fetched data. The processor may further generate a record relating to the entity, where the record may include pointers that corresponds to addresses storing the fetched data. The processor may further identify the fetched data based on the record. The processor may identify values in the fetched data to generate indicator data with use of the values. The indicator data may include indicators that relate to the entity. The processor may further aggregate the indicator data to generate aggregated data. The aggregated data may include two or more indicators relating to the entity. The processor may further merge indicators in the aggregated data to generate assessed data. The processor may further output the state data in a form of the assessed data.

### CROSS-REFERENCE TO RELATED APPLICATION

This application claims priority under 35 U.S.C. § 119(e) to U.S. Provisional Application No. 62/126,721 filed on Mar. 2, 2015. The disclosure of the Provisional Application is hereby incorporated by reference in its entirety.

### BACKGROUND

Unless otherwise indicated herein, the materials described in this section are not prior art to the claims in this application and are not admitted to be prior art by inclusion in this section.

Entities such as economies and financial markets may impact each other. A processor may analyze data relating to two or more entities to determine how the two or more entities impact each other. In some examples, each entity may include sub-entities such as sectors, businesses, etc. The processor may further analyze data relating to the sub-entities to determine how entities and respective sub-entities impact each other.

### SUMMARY

In some examples, systems effective to output state data related to an entity are generally described. The systems may include a memory, a fetch module, a bucket module, an indicator module, an aggregator, and an assessment module, configured to be in communication with the memory. The fetch module may be configured to fetch source data from one or more data sources to produce fetched data. The fetch module may be further configured to store the fetched data in an address of the memory. The bucket module may be configured to analyze the fetched data stored in the memory. The bucket module may be further configured to generate a record relating to the entity, where the record may include a pointer that corresponds to the address that stores the fetched data. The indicator module may be configured to identify the fetched data based on the pointer in the record. The indicator module may be further configured to identify one or more values in the fetched data. The indicator module may be further configured to generate indicator data with use of the one or more values, where the indicator data may include one or more indicators that relate to the entity. The indicator module may be further configured to store the indicator data in the memory. The aggregator may be configured aggregate the indicator data to generate aggregated data, where the aggregated data may include one or more groups of indicators relating to the entity. The aggregator may be further configured to store the aggregated data in the memory. The assessment module may be configured to assess the aggregated data to generate assessed data. The assessment data may be further configured to store the assessed data in the memory. The assessment data may be further configured to output the state data in a form of the assessed data.

In some examples, an entity state data detection unit is generally described. The entity state data detection unit may include a memory, and a processor configured to be in communication with the memory. The processor may be configured to receive a request from a device to output state data related to the entity. The processor may be further configured to fetch source data from one or more data sources to produce fetched data. The processor may be further configured to store the fetched data in the memory. The processor may be further configured to analyze the fetched data stored in the memory. The processor may be further configured to generate a record relating to the entity. The processor may be further configured to identify the fetched data based on the record. The processor may be further configured to identify one or more values in the fetched data. The processor may be further configured to generate indicator data with use of the one or more values, where the indicator data may include one or more indicators that relate to the entity. The processor may be further configured to aggregate the indicator data to generate aggregated data, where the aggregated data may include one or more groups of indicators relating to the entity. The processor may be further configured to assess the aggregated data to generate assessed data. The processor may be further configured to output the state data in a form of the assessed data.

In some examples, methods for outputting state data related to an entity are generally described. The methods may include receiving, by a processor of an entity state data detection unit, a request from a device to output state data related to the entity. The methods may further include fetching, by a fetch module of the entity state data detection unit, source data from one or more data sources to produce fetched data. The methods may further include analyzing, by a bucket module of the entity state data detection unit, the fetched data. The methods may further include generating, by the bucket module of the entity state data detection unit, a record relating to the entity, wherein the record includes a pointer that corresponds to an address that stores the fetched data. The methods may further include identifying, by an indicator module of the entity state data detection unit, the fetched data based on the record. The methods may further include identifying, by the indicator module of the entity state data detection unit, one or more keywords in the fetched data. The methods may further include transforming, by the indicator module of the entity state data detection unit, the one or more keywords into the one or more values. The methods may further include generating, by the indicator module of the entity state data detection unit, indicator data with use of the one or more values, where the indicator data may include one or more indicators that relate to the entity. The methods may further include aggregating, by an aggregator of the entity state data detection unit, the indicator data to generate aggregated data, where the aggregated data may include groups of indicators relating to the entity. The methods may further include assessing, by an assessment module of the entity state data detection unit, the aggregated data to generate assessed data. The methods may further include outputting, by the assessment module of the entity state data detection unit, the state data in a form of the assessed data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to implement an entity state data detection unit;

FIG. 2 illustrates the example system of FIG. 1 with additional detail relating to generation of prediction data and assessed data by an entity state data detection unit;

FIG. 3A illustrates the example system of FIG. 1 with additional detail relating to output of an interface by an entity state data detection unit;

FIG. 3B illustrates an example of an interface output by an entity state data detection unit;

FIG. 3C illustrates an example of an interface output by an entity state data detection unit;

FIG. 3D illustrates an example of an interface output by an entity state data detection unit;

FIG. 3E illustrates an example of an interface output by an entity state data detection unit;

FIG. 3F illustrates an example of an interface output by an entity state data detection unit;

FIG. 3G illustrates an example of an interface output by an entity state data detection unit;

FIG. 3H illustrates an example of an interface output by an entity state data detection unit;

FIG. 3I illustrates an example of an interface output by an entity state data detection unit;

FIG. 3J illustrates an example of an interface output by an entity state data detection unit;

FIG. 3K illustrates an example of an interface output by an entity state data detection unit;

FIG. 3L illustrates an example of an interface output by an entity state data detection unit;

FIG. 3M illustrates an example of an interface output by an entity state data detection unit;

FIG. 4 illustrates a flow diagram for an example process to implement an entity state data detection unit;

all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

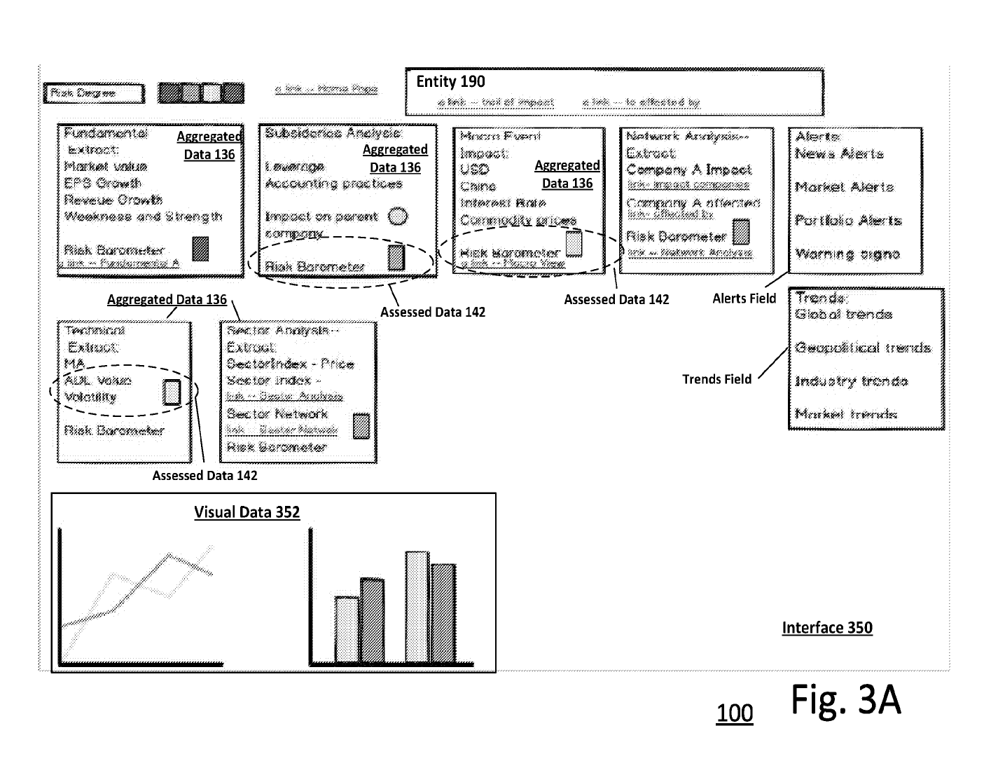

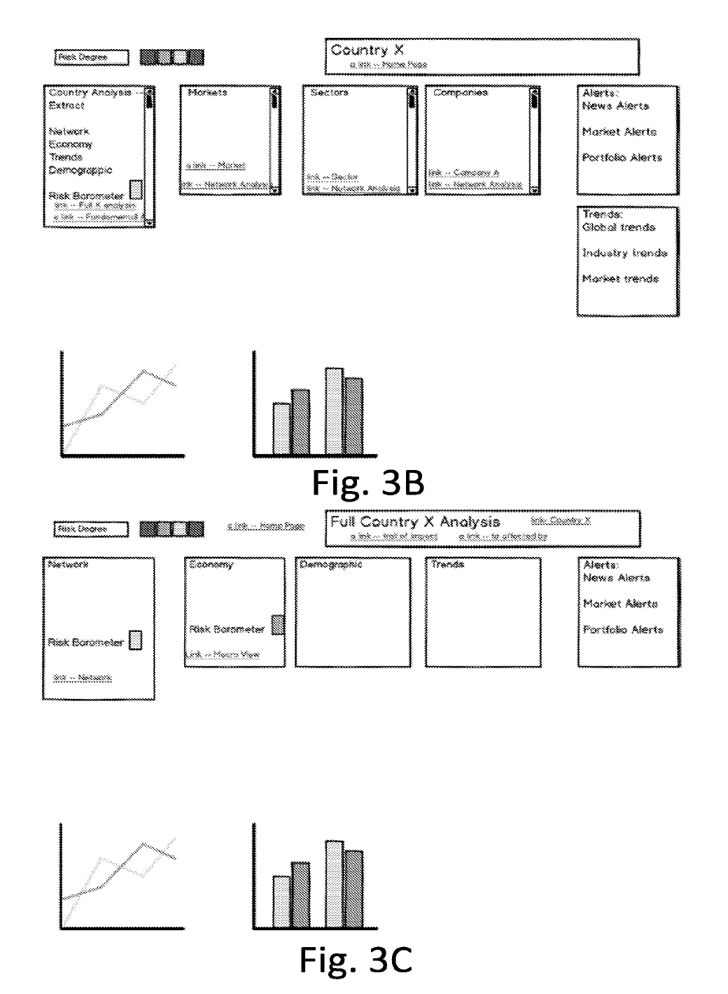

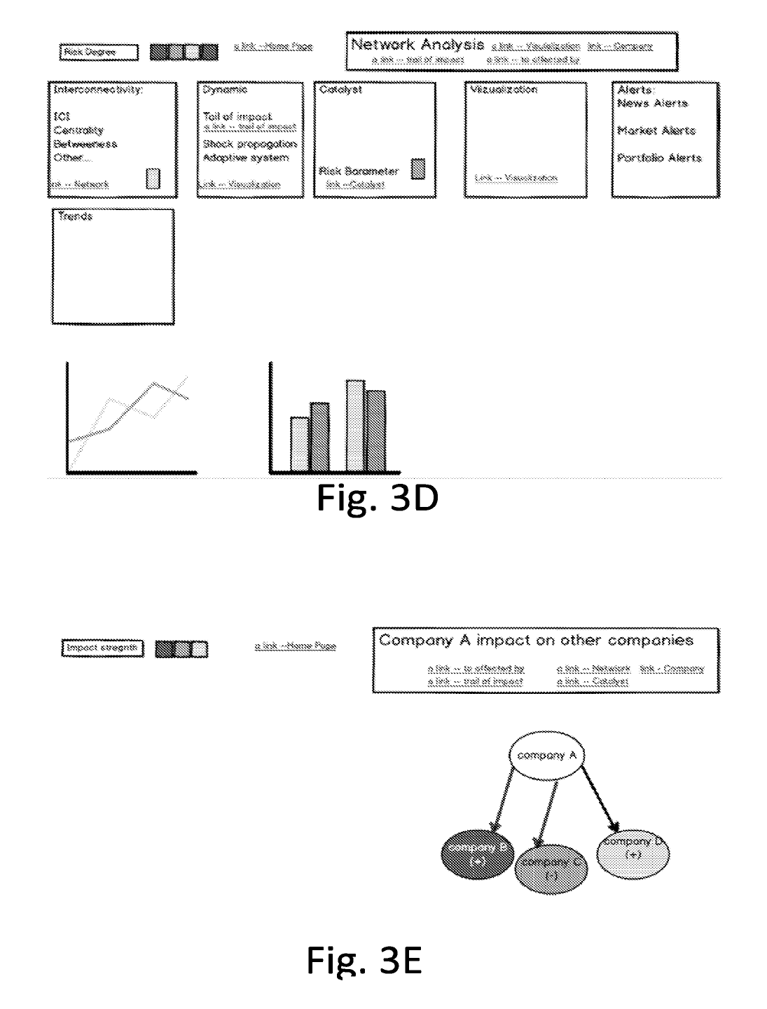

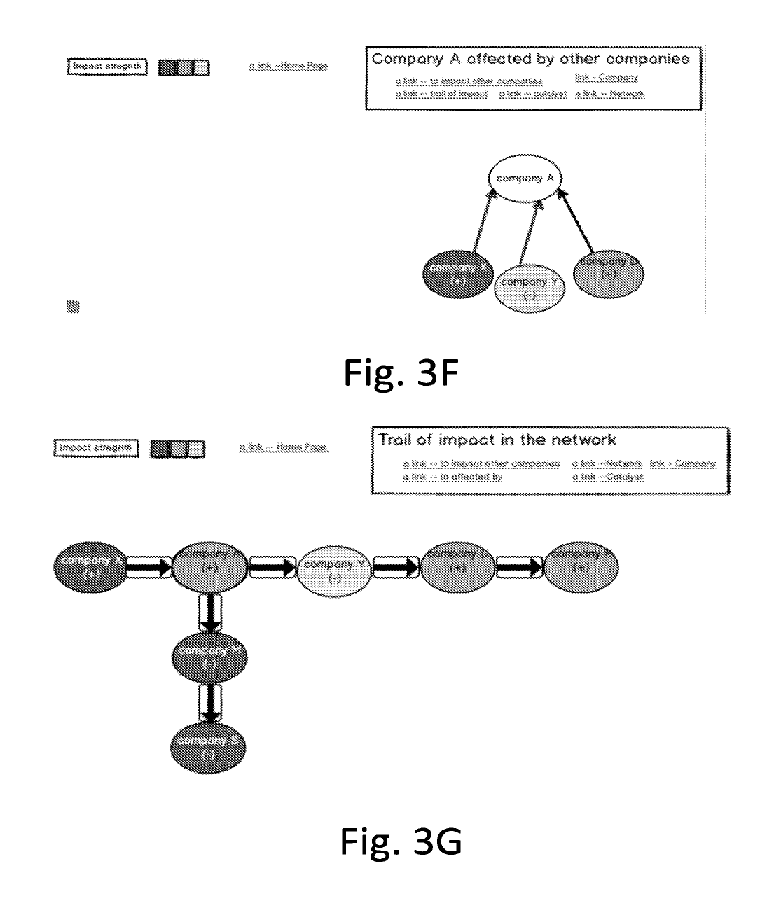

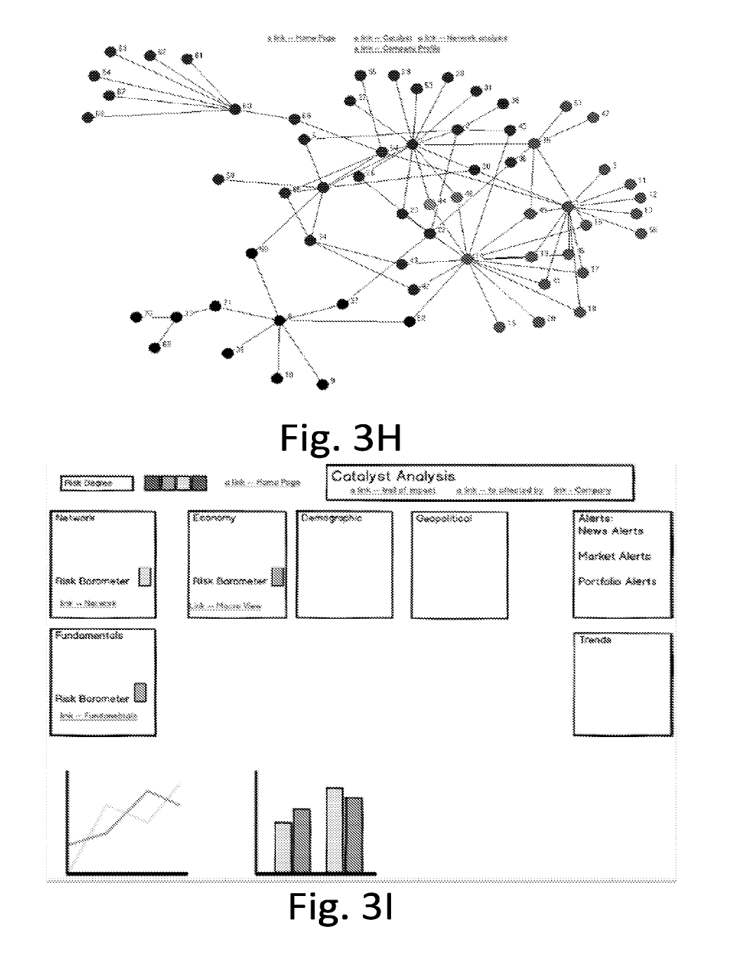

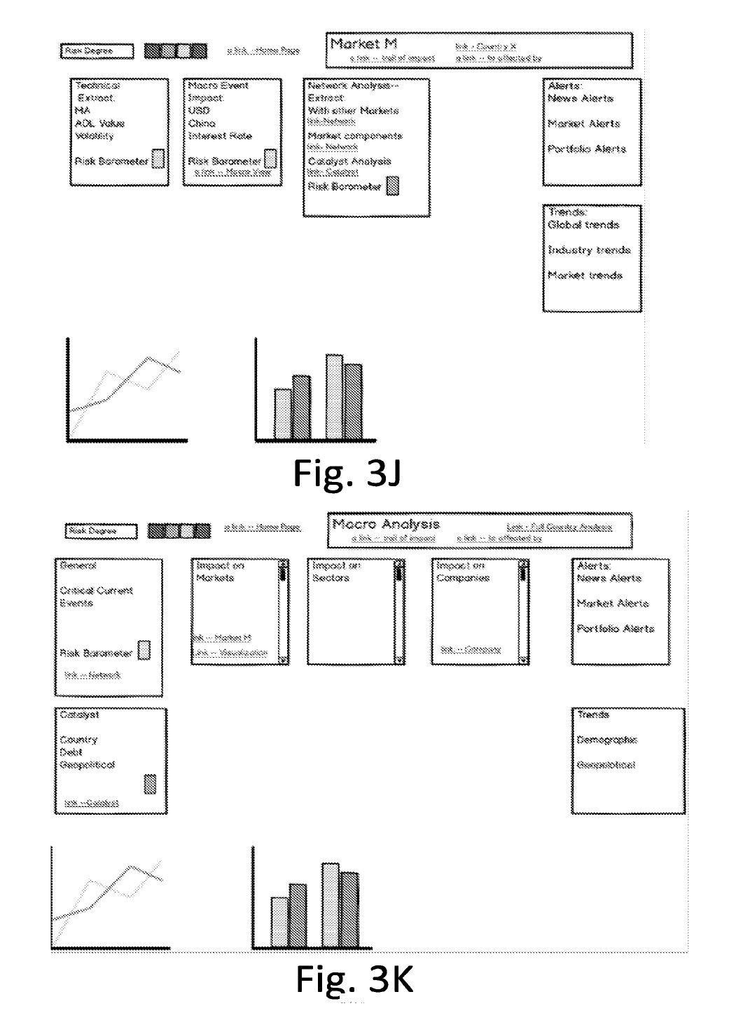

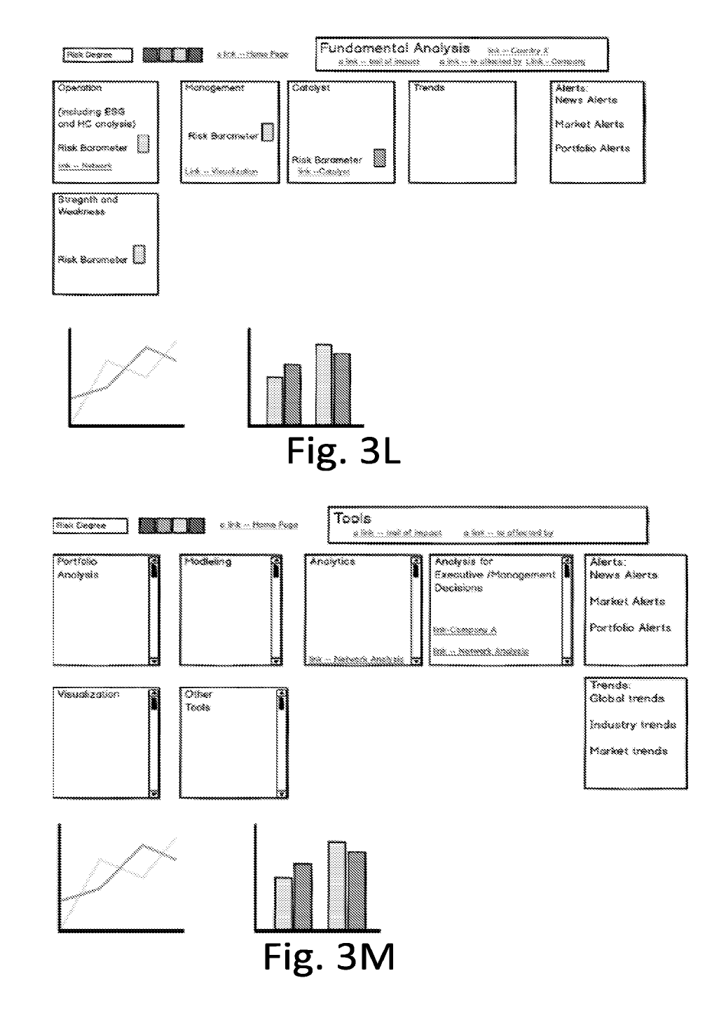

In brief, data may be fetched from data sources and stored in a data warehouse. The fetched data may be cleaned or normalized, organized and categorized. Thereafter, the cleaned data may be analyzed and manipulated based on indicators and analytical models. Assessments may thereafter be performed on an entity. As shown in FIG. 3A a user may issue a query for an entity and view an interface created for that entity. The user may thereafter navigate the information displayed by the interface to analyze one or more entities such as a country, an economy, etc. Information may retrieved from the data warehouse, where calculations and analysis have been stored, such that the retrieved information may rendered and shown in fields associated with aspects such as fundamental, macro event impact, etc.

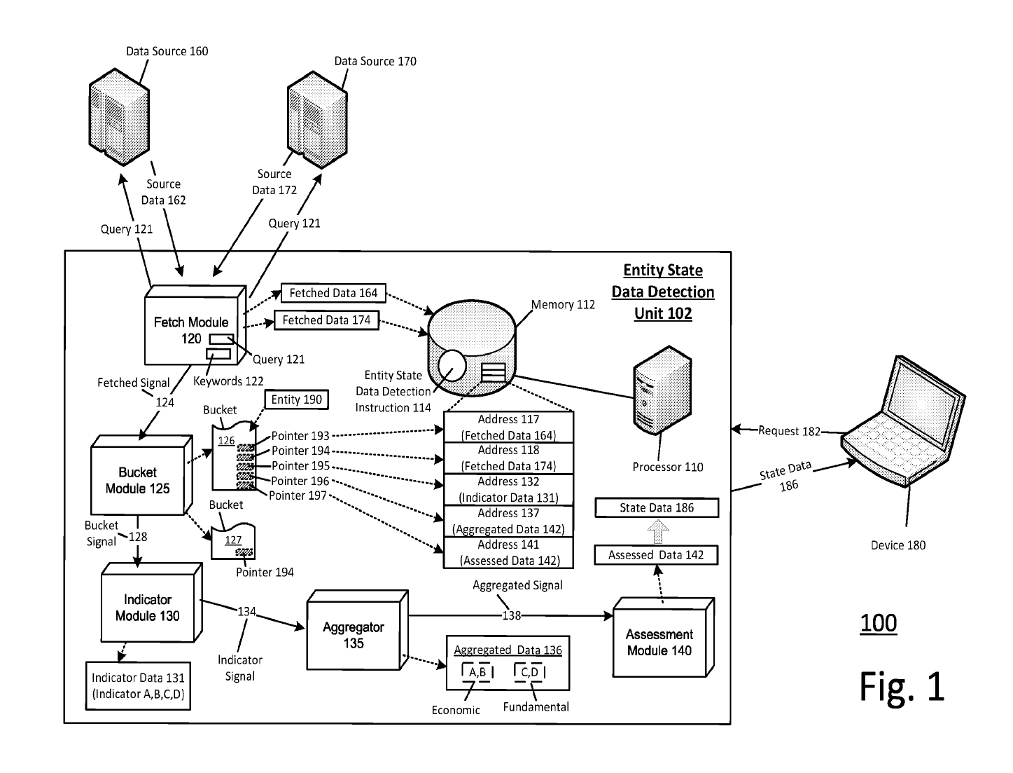

FIG. 1 illustrates an example system 100 that can be utilized to implement an entity state data detection unit, arranged in accordance with at least some embodiments described herein. System 100 may be implemented with an entity state data detection unit 102. In some examples, entity state data detection unit 102 may be a part of a computing infrastructure such as a network data center. Entity state data detection unit 102 may be a device that includes a processor 110, a memory 112, and one or more computing components and/or modules such as a fetch module 120, a bucket module 125, an indicator module 130, an assessment module 140, an aggregator 135. Processor 110, memory 112, fetch module 120, bucket module 125, indicator module 130, aggregator 135, and/or assessment module 140, may be configured to be in communication with each other. In some examples, fetch module 120, bucket module 125, indicator module 130, aggregator 135, and/or assessment module 140 may be components of processor 110 such that processor 110 may be configured to perform operations of each of the modules. In some examples, processor 110 may be configured to control operations of fetch module 120, bucket module 125, indicator module 130, aggregator 135, and/or assessment module 140.

Memory 112 may be a part of a data warehouse. Memory 112 may be a memory unit or memory system that may include volatile and/or non-volatile memory. Memory 112 may be configured to store an entity state data detection instruction 114. In some examples, entity state data detection instruction 114 may include instructions effective to facilitate operations of processor 110, fetch module 120, bucket module 125, indicator module 130, assessment module 140, and/or aggregator 135. In some examples, memory 112 may configured to store data obtained and/or generated by processor 110, fetch module 120, bucket module 125, indicator module 130, assessment module 140, and/or aggregator 135. In some examples, entity state data detection instruction 114 may include instructions related to techniques such as complex network theory, computational neuroscience, cognitive computing, ontology modeling, natural language processing, unstructured information management architecture (UIMA), etc.

In some examples, each module, including fetch module 120, bucket module 125, indicator module 130, assessment module 140, and/or aggregator 135, may be a hardware component of entity state data detection unit 102. For example, each module may be a device, a processor, a controller, or an integrated circuit such as a programmable circuit including transistors, etc. In examples where one or more modules are programmable circuits, processor 110 may be configured to program circuitry of the one or more modules based on entity state data detection instruction 114. In some examples, each module may include instructions executable by hardware.

Entity state data detection unit 102 may be configured to be in communication with one or more data sources, such as a data source 160 and a data source 170. Entity state data detection unit 102 may be configured to be in communication with data sources 160, 170 through a network such as the Internet. Examples of data sources 160, 170 may include, but not limited to, open sources that provide information on Securities and Exchange Commission (SEC) filings, data vendor providers such as economic data providers or market data providers, etc. Fetch module 120 may be configured to fetch source data 162 from source 160 and fetch source data 172 from source 170. Examples of source data 162, 172 may include, but not limited to, market data such as prices and volume, economic data, geographical data, etc. In some examples, fetch module 120 may be configured to fetch source data 162, 172, periodically based on a period that may be defined by entity state data detection instruction 114, or based on a period that may be defined by a user of system 100. Source data 162, 172 may relate to one or more entities.

In some examples, entity state data instruction 114 may include instructions relating to data fetching such as a fetching application program interface (API) or instructions to fetch data from a data feed. Fetch module 120 may fetch source data 162, 172 based on the instructions relating to data fetching in entity state data instruction 114. In some examples, fetch module 110 may be configured to generate one or more queries, such as a query 121, where query 121 may include one or more keywords 122. In some examples, query 121 may be a query to fetch data from data sources 160, 170, or from an internal search engine located within entity state data detection unit 102. Keywords 122 may include, but not limited to, text, numbers, a date, a time, etc. Keywords 122 may be defined by entity state data detection instruction 114 and/or a user of system 100. In response to generating query 121, fetch module 120 may send query 121 to data sources 160, 170 to fetch or request source data 162, 172 relating to keywords 122.

In some examples, fetch module 120 may store source data 162, 172 in memory 112. In some examples, fetch module 120 may fetch source data 162, 172 and in response, may generate fetched data 164, 174. Fetched data 164, 174 may each be a subset of source data 162, 172, respectively. In some examples, fetch module 120 may send a fetched signal 124 to bucket module 125, where fetched signal 124 may be a notification to notify bucket module 125 that fetched data 164, 174 are generated and are stored in addresses 117, 118 of memory 112. In some examples, data source 160, 170 may provide real-time data. For example, data source 160 may be a server associated with a stock exchange, and prices of stocks may be constantly updated throughout a trading day. Fetch module 120 may periodically pull real-time data from data source 160, 170 and in response, update fetched data stored in memory 112.

In some examples, entity state data detection instruction 114 may include data cleansing instructions such that processor 110 or fetch module 120 may perform data cleansing on source data 162, 174 prior to a generation of fetched data 164, 174. Examples of data cleansing may include, but are not limited to, detecting and correcting corrupted data from a table or database, identifying incomplete, inaccurate, incorrect data in a table or database and replacing, modifying, or deleting the identified data, harmonization and standardization of data such as modifying short codes into actual words, etc. Fetched module 120 may generate fetched data 164, 174 in response to a completion of data cleansing performed by processor 110 or fetch module 120.

In some examples, entity state data detection unit 102 may receive a request 182 from a device 180, where request 182 may relate to an entity 190. Bucket module 125 may be configured to generate or update one or more buckets, such as a bucket 126, where bucket 126 may represent entity 190. A bucket may be a record including one or more pointers, where each pointer may point to an address in memory 112. Each bucket may represent an entity. In some examples, each bucket may be stored in a memory module of bucket module 125. Bucket module 125 may identify addresses 117, 118 indicated by fetched signal 124. In response to identifying addresses 117, 118, bucket module 125 may analyze fetched data 162, 172 stored in addresses 117, 118 of memory 112. Based on the analysis of fetched data 162, 172, bucket module 125 may generate pointers 193, 194 based on addresses 117, 118, and may store pointers 193, 194 in bucket 126.

Bucket module 125 may be further configured to identify relationships among two or more buckets. For example, bucket module 125 may compare bucket 126 with a bucket 127 to identify relationships between bucket 126 and bucket 127. Bucket module 125 may identify common elements in bucket 126 and bucket 127, such as a common pointer 194 pointing to address 118 in memory 112, and determine that bucket 126 may relate to bucket 127. Bucket module 125 may further generate a bucket signal 128 and send bucket signal 128 to indicator module 130, where bucket signal 128 may be a notification that bucket module 125 has updated bucket 126. In some examples, each bucket may be represented as a table, and identifying common elements among buckets may include identifying common contents in the table such as a common date. In some examples, bucket signal 128 may include indications of one or more buckets that were recently updated, such as bucket 126.

Indicator module 130 may receive bucket signal 128 and in response and identify bucket 126 in bucket signal 128. In response to identifying bucket 126, indicator module 130 may generate indicator data 131 for entity 190 based on the pointers stored in bucket 126. For example, indicator module 130 may analyze source data 162, 172 that are stored in addresses 117, 118, where addresses 117, 118 corresponds to pointers 193, 194 stored in bucket 126. In some examples, indicator data 131 may include indications of one or more indicators of entity 190. Indicators of an entity may include quantitative values effective to describe the entity. For example, indicator data 131 may include indicators that may be quantitative vales effective to describe entity 190. Type of indicators may include, but not limited to, fundamental, economic, market, microstructure, etc. In some examples, fundamental indicators, such as earnings growth, leverage (e.g. debt-to-equity), accruals, profit margin, etc., of entity 190 may describe a fundamental aspect of entity 190. In some examples, fundamental indicators may be grouped into indicator groups such as profitability indicators, financial stability and solvency indicators, operating risk indicators, etc. Each type of indicator, and/or each groups of indicators, may be effective to describe a respective aspect of entity 190. For example, economic indicators may be effective to describe an economic aspect of entity 190.

In some examples, entity state data detection instruction 114 stored in memory 112 may include algorithms and/or models effective to generate indicator data 131. For example, entity state data detection instruction 114 may include the generalized autoregressive conditional heteroscedasticity (GARCH) model effective to determine a volatility of entity 190. In some examples, indicator module 130 may use more than one model or algorithm to generate a same piece of indicator data.

In some examples, generation of indicator data 131 for a company may include analysis of financial statements, business health, management, and competitive advantage of the company. Analysis of a business health may include analyzing a financial state, such as dividends paid, operating cash flow, new equity issues, and capital financing, of the company. In some examples, indicator module 130 may generate an indicator relating to a value of a company. For example, indicator module 130 may execute entity state data detection instruction 114 to determine an estimate for a revenue/cash flow growth rate and an estimate of a level of risk relating to the company.

In an example where an entity is an economy, indicators may include gross domestic product (GDP) growth in past years and estimates of the GDP growth in future years. Indicators for an economy may also include indices reflecting whether a particular region or country is marked as high risk based on a solvency of the particular region or country. Indicators of an economy may also include interest rates, inflation, unemployment, exchange rates, productivity, energy prices, etc. Indicators of an economy may also include indicators relating to assets such as equities, bonds, domestic securities, and sector analysis such as total sales, price levels, effects of competing products and foreign competitions, etc.

Indicator module 130 may store indicator data 131 of entity 190 in an address 132 of memory 112. Indicator model 130 may generate an indicator signal 134 and may send indicator signal 134 to assessment module 140, where indicator signal 134 may be a notification that indicator data 131 have been generated for entity 190. In some examples, indicator signal 134 may include indications of bucket 126, entity 190, and/or address 132 of memory 112. In some examples, indicator module 130 may notify bucket module 125 that indicator data 131 is stored in address 132. Bucket module 125 may generate a pointer 195 to point to address 132, and may store pointer 195 in bucket 126.

Aggregator 135 may receive indicator signal 134, and in response, may identify address 132 in indicator signal 134. In response to identifying address 132 in indicator signal 134, aggregator 135 may execute entity state data detection instruction 114 to aggregate indicator data 131. Aggregation of indicator data 131 may include analyzing two or more pieces of indicators included in the indicator data being aggregated. In some examples, aggregation of indicator data 131 may include analysis of two or more indicators under a type of indicator. For example, aggregator 135 may aggregate indicator data 131 by analyzing two or more indicators under a group of economic indicators of entity 190. As a result of the aggregation, aggregator 135 may generate aggregated data 136, where aggregated data 136 may be effective to reflect a state of an aspect of entity 190. For example, when aggregator 135 aggregates indicator data 131 by analyzing economic indicators, aggregator 135 may generate aggregated data 136 that may be effective to reflect an economic state of entity 190. Aggregator 135 may further generate aggregated data relating to fundamental, operating risk, and/or market indicators, etc. Aggregator 135 may store aggregated data 136 in an address 137. Aggregator 135 may generate an aggregated signal 138, where aggregated signal 138 may include an indication of address 137. Aggregator 135 may send aggregated signal 138 to assessment module 140. In some examples, aggregator 135 may notify bucket module 125 that aggregated data 136 is stored in address 137. Bucket module 125 may generate a pointer 196 to point to address 137, and may store pointer 196 in bucket 126

Assessment module 140 may receive aggregated signal 138 and may identify address 137 indicated by aggregated signal 138. In response to identifying address 137 indicated by aggregated signal 138, assessment module 140 may execute entity state data detection instruction 114 to assess aggregated data 136 stored at address 137. As will be described in more detail below, assessment module 140 may assess one or more pieces of aggregated data 136 to generate assessed data 142. Assessment module 140 may output state data 186 in a form of assessed data 142, where state data 186 may be effective to reflect economical and/or financial states of entity 190 and/or of one or more entities different from entity 190.

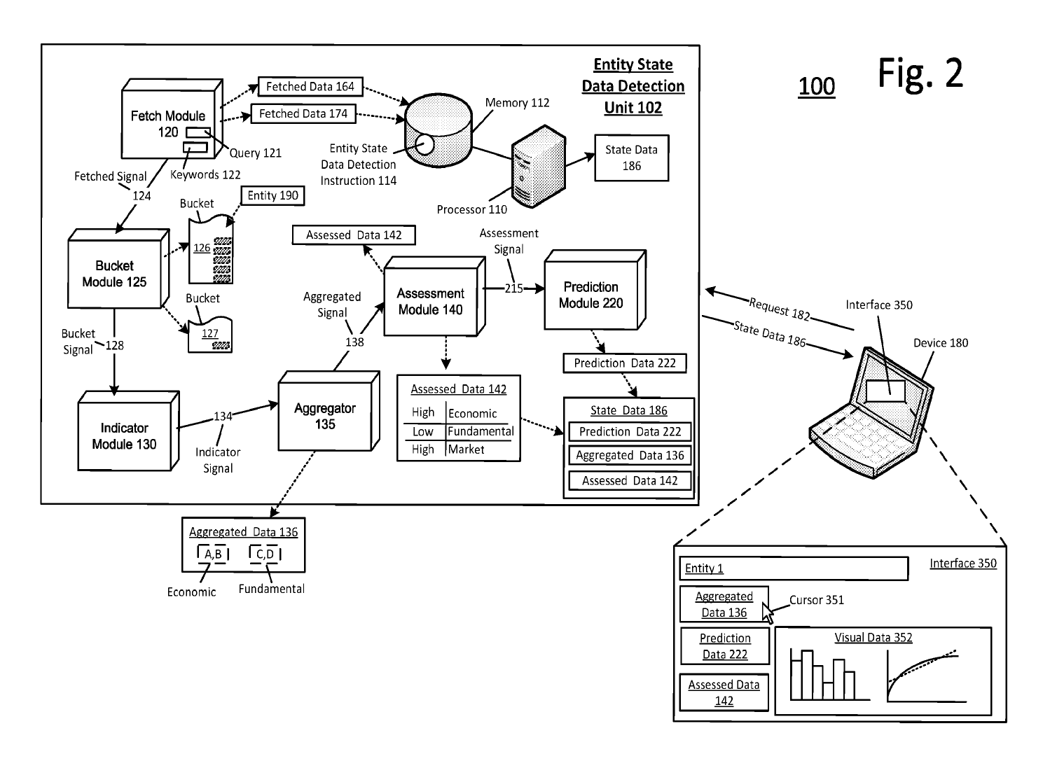

FIG. 2 illustrates example system of 100 FIG. 1 with additional detail relating to generation of prediction data and assessed data by an entity state data detection unit, arranged in accordance with at least some embodiments described herein. FIG. 2 is substantially similar to system 100 of FIG. 1, with additional details. Those components in FIG. 2 that are labeled identically to components of FIG. 1 will not be described again for the purposes of clarity.

Assessed data 142, generated by assessment module, may relate to risk associated with aggregated data 136. For example, assessed data 142 may indicate a level of risk of aggregated data relating to an economic aspect of entity 190, and may indicate a level of risk of aggregate data relating to a market aspect of entity 190. In response to assessing aggregated data 136, assessment module 140 may generate assessed data 142 and may store assessed data 142 in address 141 of memory 112. In some examples, assessment module 140 may notify bucket module 125 that assessed data 142 is stored in address 141. Bucket module 125 may generate a pointer 197 to point to address 141, and may store pointer 197 in bucket 126.

Entity state data detection unit 102 may further include a prediction module 220. Prediction module 220 may be configured to be in communication with processor 110, memory 112, fetch module 120, bucket module 125, indicator module 130, aggregator 135, and/or assessment module 140. Prediction module 220 may be configured to execute entity state data detection instruction 114 to generate prediction data 222. In some examples, entity state data detection instruction 114 may include algorithms and/or models such as ontology models, cognitive computing techniques, augmentation system techniques, effective to generate prediction data 222. Prediction module 220 may apply models stored in entity state data detection instructions 114 to assessed data 142 in order to generate prediction data.

In some examples, a probability of an occurrence of an event may be based on a difference between a present event and a past event. Prediction module 220 may evaluate a past event based on indicators in indicator data 131, 210 at a time of the past event, and based on a location of the past event. Prediction module 220 may further evaluate a present event based on indicators in indicator data 131, 210 at a present time of the present event, and based on a location of the present event. In response to the evaluations of the past and present events, prediction module 220 may determine a difference between the past and present events to generate prediction data 222.

Processor 110 may generate state data 186 by compiling aggregated data 136, assessed data 142, and/or prediction data 222. Processor 110 may send state data 186 to device 180 to be displayed on a display of device 180. State data 186 may be rendered by device 180, such that state data 186 may be displayed as an interface 350 on a display of device 180. When state data 186 is displayed as interface 350, aggregated data 136, assessed data 142, prediction data 222, may also be displayed. In some examples, processor 110 may be further configured to generate visual data 352, where visual data 352 may be data relating to charts, tables, graphs, etc., that represents assessed data 142, prediction data 222, and interaction data 312 visually.

FIG. 3A illustrates example system of 100 FIG. 1 with additional detail relating to output of an interface by an entity state data detection unit, arranged in accordance with at least some embodiments described herein. FIG. 3A is substantially similar to system 100 of FIG. 1, with additional details. Those components in FIG. 3A that are labeled identically to components of FIG. 1 will not be described again for the purposes of clarity.

A user of device 180 may view state data 186 on the display of device 180. A user of device 180 may use an input device, such as a computer mouse or keyboard, to control a cursor, such as a cursor 351 (shown on interface 350), to select data being displayed in interface 350. Selection of data displayed in interface 350 may cause device 180 to generate a request 330, where request 330 may be a request to modify state data 186.

In some examples, interface 350 may further include fields relating to an investment risk, trends, alerts and links (e.g. hyperlinks) to analysis tools, websites, news articles, etc. The user of device 180 may be given an option to customize one or more fields in interface 350, or to remove one or more fields from interface 350. In some examples, entity state data detection unit 102 may update the fields in interface 350 periodically without a user request from device 180. In an example, a trends field of interface 350 may be related to the most important trends that are currently happening in the geopolitical scene, economic scene, market, sector, etc. In some examples, one or more fields, such as the trends field, may be updated periodically. In another example, an alerts field of interface 350 may relate to alerts, such as news alerts. As a result of including the alerts field, the user of device 180 may have access to the latest news of what is happening in one or more markets, sectors, economies, etc. while viewing other information of entity 190.

Interface 350 may include one or more respective risk barometers for each piece of aggregated data 136. Each risk barometer may be related to a piece of assessed data such as assessed data 142. In some examples, each risk barometer may be shown as different color, shade, number, symbol, etc. Assessment module 140 may apply one or more models to indicators of each aspect (e.g. aggregated data 136) to derive levels of risk (e.g. assessed data 142). Assessment module 140 may be configured to transform assessed data 142 into risk barometer, such as by mapping levels of risk to colors in order to generate and render the risk barometers. Each risk barometer may be a function of indicators.

In an example, a user may view interface 350 to evaluate state data 186. For example, aggregated data 136 may indicate that a solvency risk of entity 190 is low but an operation risk of entity 190 is high, and an economy is entering a recession. Assessment module 140 may assess aggregated data 136 to generate assessed data 142 that indicates even though there is no risk of solvency, the solvency risk of entity 190 may rise based on the operating risk of entity 190 and the state of the economy. In some examples, a user of device 180 viewing interface 350 may be a customer, a supplier, a lender, a business partner or an employee relating to a company. If entity 190 is a country, a user viewing interface 350 may use information provided by interface 350 to evaluate incidents such as potential business collaboration with the country, living in the country, visiting the country, etc.

A system in accordance with the present disclosure may provide a holistic system effective to perform a forensic investigation approach to analyze financial data, thus uncovering footprints that activities leave in available data sources. Each economy and financial market is viewed as a property of the system, and each property is ignited by different (sometimes simultaneous) human actions (or events). Each entity (i.e., economy, market, sector, company, etc.) is the aggregate of all actions and reactions which are represented in different data sources. Therefore, the holistic system may provide an all-encompassing view on risks associated with different aspects of the entities. Under the holistic system, markets and economies may be viewed holistically. For example, a holistic view on a plurality of data sources may include a view of actions reflected in data sources (e.g., transactions in the stock market or at the store or online that may be documented in data sources). The holistic system provides a full understanding of economies and information of respective particles under the economy by gathering information from the plurality of data sources. The holistic system may also integrate different disciplines and analytical tools. Analysis of different data sources and different types of information (or actions/events) are performed using the different tools, measures and theories. The holistic system may also integrate information by use of computational tools that may be capable of handling and analyzing vast (and versatile) information.

The holistic system may also provide a network-type analysis such as analysis on an economy. For instance, the holistic system may perform inter-connectivity analysis, causality analysis (cause and effect) such that the analysis performed are focused on causality rather than on correlation, factors/reasons attributing to the causality relationship identified in a network such as an economy, propagation of a shock, percolation of a shock, adaptive system (i.e., how a system adapt to a change), network dynamics (trends which may change the network and using different data sources/types), multi-layered network analysis such as a top-down approach (i.e., from global economy to the individual company), a bottom-up analysis (i.e., from the individual company to the global economy) for each entity (i.e., economies, markets, sectors, companies, asset classes and any other possible relationship).

The holistic system may also analyze a buildup of risks and catalyst associated with the risks. When there is a buildup of risk in a network, there may be a catalyst that may throw the network out of balance. Thus, the holistic system provides a platform to analyze the risks and associated catalyst constantly and simultaneously. Causality and interconnectivity within a network may relate to the risks, an increase in interconnectivity may increase risks that may be in the network, and an increase in risks may increase the interconnectivity gets, such that a feedback effect (or a loop of reactions based on each other especially in times of a crisis) is shown by the holistic system. The holistic system provides the platform to analyze risks in combinations based on actions reflected in a plurality of data sources. The holistic system allows users to understand that risk does not just happen or a crisis does not just happen—humans act in markets and economies, and causes the consequence of human actions. The holistic system allows users to view what is happening with more than one data source or aspects of an entity (e.g. analyze fundamental indicators with market indicators) in order to perform evaluations on economies and other entities. Each data source and each analysis will add one more piece to an entire puzzle and help see and understand a full situation.

FIG. 3B illustrates an example of an interface output by an entity state data detection unit, arranged in accordance with at least some embodiments described herein. FIG. 3B is substantially similar to interface 350 of FIG. 3A, with additional details. Those components in FIG. 3B that are labeled identically to components of FIG. 3A will not be described again for the purposes of clarity.

FIG. 3B shows a screenshot relating to analysis of a country that may appear in interface 350 on a display of device 180.

FIG. 3C illustrates an example of an interface output by an entity state data detection unit, arranged in accordance with at least some embodiments described herein. FIG. 3C is substantially similar to interface 350 of FIG. 3A, with additional details. Those components in FIG. 3C that are labeled identically to components of FIG. 3A will not be described again for the purposes of clarity.

FIG. 3C shows a screenshot relating to a full analysis of a country that may appear in interface 350 on a display of device 180.

FIG. 3D illustrates an example of an interface output by an entity state data detection unit, arranged in accordance with at least some embodiments described herein. FIG. 3D is substantially similar to interface 350 of FIG. 3A, with additional details. Those components in FIG. 3D that are labeled identically to components of FIG. 3A will not be described again for the purposes of clarity.

FIG. 3D shows a screenshot relating to a network analysis that may appear in interface 350 on a display of device 180.

FIG. 3E illustrates an example of an interface output by an entity state data detection unit, arranged in accordance with at least some embodiments described herein. FIG. 3E is substantially similar to interface 350 of FIG. 3A, with additional details. Those components in FIG. 3E that are labeled identically to components of FIG. 3A will not be described again for the purposes of clarity.

FIG. 3E shows a screenshot relating to analysis of an impact on a plurality of companies by a particular company that may appear in interface 350 on a display of device 180.

FIG. 3F illustrates an example of an interface output by an entity state data detection unit, arranged in accordance with at least some embodiments described herein. FIG. 3F is substantially similar to interface 350 of FIG. 3A, with additional details. Those components in FIG. 3F that are labeled identically to components of FIG. 3A will not be described again for the purposes of clarity.

FIG. 3F shows a screenshot relating to analysis of effects on a particular company by a plurality of companies that may appear in interface 350 on a display of device 180.

FIG. 3G illustrates an example of an interface output by an entity state data detection unit, arranged in accordance with at least some embodiments described herein. FIG. 3G is substantially similar to interface 350 of FIG. 3A, with additional details. Those components in FIG. 3G that are labeled identically to components of FIG. 3A will not be described again for the purposes of clarity.

FIG. 3G shows a screenshot relating to analysis of a trail of impact in a network that may appear in interface 350 on a display of device 180.

FIG. 3H illustrates an example of an interface output by an entity state data detection unit, arranged in accordance with at least some embodiments described herein. FIG. 3H is substantially similar to interface 350 of FIG. 3A, with additional details. Those components in FIG. 3H that are labeled identically to components of FIG. 3A will not be described again for the purposes of clarity.

FIG. 3I shows a screenshot relating to analysis of a network that may appear in interface 350 on a display of device 180.

FIG. 3I illustrates an example of an interface output by an entity state data detection unit, arranged in accordance with at least some embodiments described herein. FIG. 3I is substantially similar to interface 350 of FIG. 3A, with additional details. Those components in FIG. 3I that are labeled identically to components of FIG. 3A will not be described again for the purposes of clarity.

FIG. 3I shows a screenshot relating to analysis of a catalyst that may appear in interface 350 on a display of device 180.

FIG. 3J illustrates an example of an interface output by an entity state data detection unit, arranged in accordance with at least some embodiments described herein. FIG. 3J is substantially similar to interface 350 of FIG. 3A, with additional details. Those components in

FIG. 3J that are labeled identically to components of FIG. 3A will not be described again for the purposes of clarity.

FIG. 3J shows a screenshot relating to a market analysis that may appear in interface 350 on a display of device 180.

FIG. 3K illustrates an example of an interface output by an entity state data detection unit, arranged in accordance with at least some embodiments described herein. FIG. 3K is substantially similar to interface 350 of FIG. 3A, with additional details. Those components in FIG. 3K that are labeled identically to components of FIG. 3A will not be described again for the purposes of clarity.

FIG. 3K shows a screenshot relating to a macro analysis that may appear in interface 350 on a display of device 180.

FIG. 3L illustrates an example of an interface output by an entity state data detection unit, arranged in accordance with at least some embodiments described herein. FIG. 3L is substantially similar to interface 350 of FIG. 3A, with additional details. Those components in FIG. 3L that are labeled identically to components of FIG. 3A will not be described again for the purposes of clarity.

FIG. 3L shows a screenshot relating to fundamental analysis that may appear in interface 350 on a display of device 180.

FIG. 3M illustrates an example of an interface output by an entity state data detection unit, arranged in accordance with at least some embodiments described herein. FIG. 3M is substantially similar to interface 350 of FIG. 3A, with additional details. Those components in FIG. 3M that are labeled identically to components of FIG. 3A will not be described again for the purposes of clarity.

FIG. 3M shows a screenshot relating to a display of tools that may appear in interface 350 on a display of device 180.

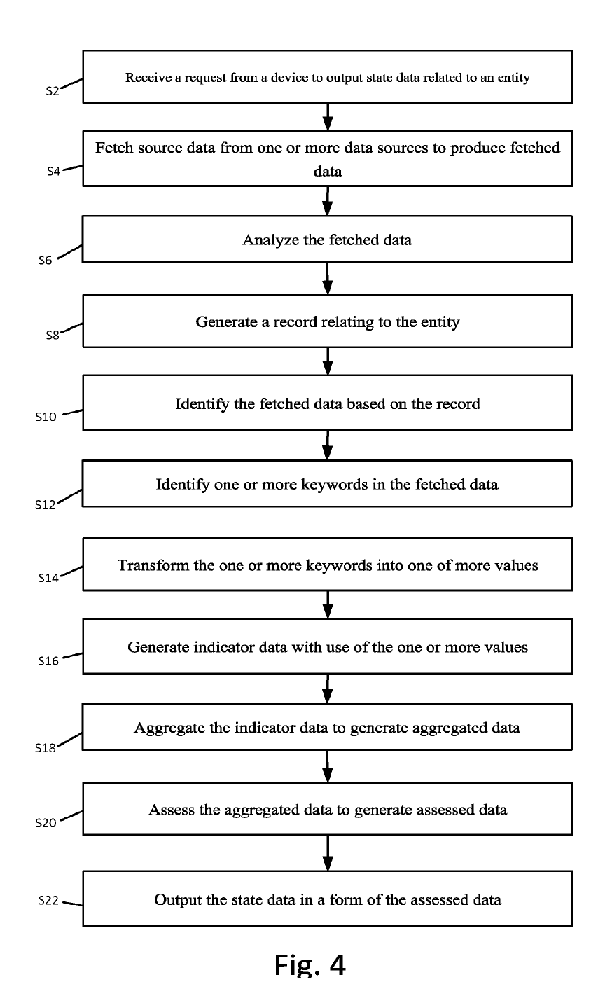

FIG. 4 illustrates a flow diagram for an example process to implement alternative training distribution based on density modification, arranged in accordance with at least some embodiments presented herein. The process in FIG. 4 could be implemented using, for example, system 100 discussed above. An example process may include one or more operations, actions, or functions as illustrated by one or more of blocks S2, S4, S6, S8, S10, S12, S14, S16, S18, S20, and/or S22. Although illustrated as discrete blocks, various blocks may be divided into additional blocks, combined into fewer blocks, or eliminated, depending on the desired implementation.

Processing may begin at block S2, “Receive a request from a device to output state data related to an entity.” At block S2, a fetch module of an entity state data detection unit may receive a request from a device to output state data relating to an entity.

Processing may continue from block S2 to block S4, “Fetch source data from one or more data sources to produce fetched data.” At block S4, the fetch module of an entity state data detection unit may fetch source data from one or more data sources to produce fetched data. The fetch module of the entity state data detection unit may store the fetched data in a memory.

Processing may continue from block S4 to block S6, “Analyze the fetched data.” At block S6, a bucket module of the entity state data detection unit may analyze the fetched data.

Processing may continue from block S6 to block S8, “Generate a record relating to the entity.” At block S8, the bucket module of the entity state data detection unit may generate a record relating to the entity. The record may include a pointer that corresponds to an address that stores the fetched data.

Processing may continue from block S8 to block S10, “Identify the fetched data based on the record.” At block S10, an indicator module of the entity state data detection unit may identify the fetched data based on the record.

Processing may continue from block S10 to block S12, “Identify one or more keywords in the fetched data.” At block S12, the indicator module of the entity state data detection unit may identify one or more keywords in the fetched data.

Processing may continue from block S12 to block S14, “Transform the one or more keywords into the one or more values.” At block S14, the indicator module of the entity state data detection unit may transform the one or more keywords into one or more values.

Processing may continue from block S14 to block S16, “Generate indicator data with use of the one or more values.” At block S16, the indicator module of the entity state data detection unit may generate indicator data with use of the one or more values. The indicator data may include one or more indicators that relate to the entity.

Processing may continue from block S16 to block S18, “Aggregate the indicator data to generate aggregated data.” At block S18, an aggregator of the entity state data detection unit may aggregate the indicator data to generate aggregated data. The aggregated data includes groups of indicators relating to the entity.

Processing may continue from block S18 to block S20, “Assess the aggregated data to generate assessed data.” At block S20, an assessment module of the entity state data detection unit may assess the aggregated data to generate assessed data.

Processing may continue from block S20 to block S22, “Output the state data in a form of the assessed data.” At block S22, the assessment module of the entity state data detection unit may output the state data in a form of the assessed data.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system effective to output state data related to an entity, the system comprising:
a memory;
a fetch module, a bucket module, an indicator module, an aggregator, and an assessment module, configured to be in communication with the memory;
the fetch module being configured to:
fetch source data from one or more data sources to produce fetched data; and
store the fetched data in an address of the memory;
the bucket module being configured to:
analyze the fetched data stored in the memory; and
generate a record relating to the entity, wherein the record includes a pointer that corresponds to the address that stores the fetched data;
the indicator module being configured to:
identify the fetched data based on the pointer in the record;
identify one or more values in the fetched data;
generate indicator data with use of the one or more values, wherein the indicator data includes one or more indicators that relate to the entity; and
store the indicator data in the memory;
the aggregator being configured to:
aggregate the indicator data to generate aggregated data, wherein the aggregated data includes one or more groups of indicators relating to the entity; and
store the aggregated data in the memory;
the assessment module being configured to:
assess the aggregated data to generate assessed data;
store the assessed data in the memory; and
output the state data in a form of the assessed data.

2. The system of claim 1, further comprising a prediction module configured to be in communication with the assessment module and the memory, the prediction module being configured to generate prediction data based on the assessed data, wherein the prediction data relates to a prediction of values of the one or more indicators related to the entity.

3. The system of claim 1, wherein the assessment module is further configured to determine respective risk level for respective aggregated data.

4. The system of claim 1, wherein the fetch module is further configured to:
generate a query including a keyword; and
send the query to the one or more data sources to fetch the source data.

5. The system of claim 1, wherein the bucket module is further configured to:
receive the address from the fetch module; and
identify the fetched data based on the address.

6. The system of claim 1, wherein the indicator module is further configured to:
identify one or more keywords in the fetched data; and
transform the one or more keywords into the one or more values.

7. The system of claim 1, further comprising a processor configured to be in communication with the memory and the assessment module, the processor being configured to:
receive a request from a device to output the state data related to the entity;
receive the state data from the assessment module; and
send the state data to a device such that the state data is to be output on a display of the device.

8. The system of claim 7, wherein the request is a first request, and the processor is further configured to:
receive a second request from the device to modify the state data; and
send the second request to the assessment module, wherein the assessment module is further configured to modify the state data based on the second request.

9. The system of claim 1, wherein:
the entity is a first entity;
the indicator data is first indicator data;
the aggregated data is first aggregated data;
the assessed data is first assessed data;
the aggregator is further configured to aggregate second indicator data to generate second aggregated data, wherein the second indicator data is associated with a second entity, the second entity is different from the first entity, and wherein the second aggregated data includes groups of indicators among the second indicator data;
the assessment module is further configured to assess the second aggregated data to generate second assessed data; and
the state data includes the first assessed data and the second assessed data.

10. An entity state data detection unit, comprising:
a memory;
a processor configured to be in communication with the memory, the processor being configured to:
receive a request from a device to output state data related to the entity;
fetch source data from one or more data sources to produce fetched data;
store the fetched data in the memory;
analyze the fetched data stored in the memory;
generate a record relating to the entity;
identify the fetched data based on the record;
identify one or more values in the fetched data;
generate indicator data with use of the one or more values, wherein the indicator data includes one or more indicators that relate to the entity;
aggregate the indicator data to generate aggregated data, wherein the aggregated data includes one or more groups of indicators relating to the entity;
assess the aggregated data to generate assessed data; and
output the state data in a form of the assessed data.

11. The entity state data detection unit of claim 10, wherein the record includes a pointer that corresponds to an address that stores the fetched data.

12. The entity state data detection unit of claim 10, wherein the processor is further configured to generate prediction data based on the assessed data, wherein the prediction data relates to a prediction of values of the one or more indicators related to the entity.

13. The entity state data detection unit of claim 10, wherein the processor is further configured to determine respective risk level for respective aggregated data

14. The entity state data detection unit of claim 10, wherein the processor is further configured to:
generate a query including an keyword; and
send the query to the one or more data sources to fetch the source data.

15. The entity state data detection unit of claim 10, wherein the processor is further configured to:
identify one or more keywords in the fetched data; and
transform the one or more keywords into the one or more values to generate the indicator data.

16. The entity state data detection unit of claim 10, wherein the processor is further configured to send the state data to a device such that the state data is to be output on a display of the device.

17. The entity state data detection unit of claim 10, wherein:
the entity is a first entity;
the indicator data is first indicator data;
the aggregated data is first aggregated data;
the assessed data is first assessed data; and
the processor is further configured to:
aggregate second indicator data to generate second aggregated data, wherein the second indicator data is associated with a second entity, the second entity is different from the first entity, and the aggregated data includes groups of indicators among the second indicator data;
assess the second aggregated data to generate second assessed data, wherein the state data includes the first assessed data and the second assessed data.

18. A method for outputting state data related to an entity, the method comprising:
receiving, by a processor of an entity state data detection unit, a request from a device to output state data related to the entity;
fetching, by a fetch module of the entity state data detection unit, source data from one or more data sources to produce fetched data;
analyzing, by a bucket module of the entity state data detection unit, the fetched data;
generating, by the bucket module of the entity state data detection unit, a record relating to the entity, wherein the record includes a pointer that corresponds to an address that stores the fetched data;
identifying, by an indicator module of the entity state data detection unit, the fetched data based on the record;
identifying, by the indicator module of the entity state data detection unit, one or more keywords in the fetched data;
transforming, by the indicator module of the entity state data detection unit, the one or more keywords into the one or more values;
generating, by the indicator module of the entity state data detection unit, indicator data with use of the one or more values, wherein the indicator data includes one or more indicators that relate to the entity;
aggregating, by an aggregator of the entity state data detection unit, the indicator data to generate aggregated data, wherein the aggregated data includes groups of indicators relating to the entity;
assessing, by an assessment module of the entity state data detection unit, the aggregated data to generate assessed data; and
outputting, by the assessment module of the entity state data detection unit, the state data in a form of the assessed data.

19. The method of claim 18, further comprising generating, by a prediction module of the entity state data detection unit, prediction data based on the assessed data, wherein the prediction data relates to a prediction of values of the one or more indicators related to the entity.

20. The method of claim 18, further comprising determining, by the assessment module of the entity state data detection unit, respective risk level for respective aggregated data.
